(19) United States
(12) Patent Application Publication
(10) Pub. No.: US 2011/0248582 A1
(43) Pub. Date: Oct. 13, 2011

(54) SWITCHED RELUCTANCE MACHINE

(75) Inventors: Piyush C. Desai, Des Plaines, IL (US); Ali Emadi, Chicago, IL (US); Umamaheshwar Krishnamurthy, Wheaton, IL (US)

(73) Assignee: Illinois Institute of Technology, Chicago, IL (US)

(21) Appl. No.: 12/758,967

(22) Filed: Apr. 13, 2010

(51) Int. Cl. H02K 37/08

(52) U.S. Cl. 310/49.44

(57) ABSTRACT

A switched reluctance machine (SRM) having a rotor and stator pole numerical relationship of S number of stator poles and R number of rotor poles, where R=2S−2, when S is greater than 4; provides improved power density, torque production, torque ripple, and is readily adaptable to existing hardware such as known controllers and the like.

### FIELD OF THE INVENTION

The present invention relates generally to a switched reluctance machine. The present invention relates more specifically to switched reluctance machines having a rotor pole and a stator pole numerical relationship of R=2S−2, where S is a number of stator poles, with S>4, and R is a number of rotor poles.

### BACKGROUND OF THE INVENTION

A switched reluctance machine (SRM) is a type of synchronous machine which can operate as a motor or a generator. Though there are no major differences in construction, SRM operates as a generator, when used to convert mechanical energy into electrical energy, or as a motor, when used to convert electrical energy into mechanical energy, and often one SRM will operate in both modes in a cycle. Hence, herein after, we shall use the term “machine” instead of motor and/or generator to include both of these operating modes.

SRMs typically include a stator having a plurality of salient stator poles and a rotor having a plurality of salient poles. During operation of this configuration, each of the stator poles are successively excited to generate a magnetic attraction force between the stator poles and corresponding rotor poles to rotate the rotor.

In general, the SRMs are simple machines with a robust construction and a number of advantages including fault tolerant capabilities, extended constant power torque-speed characteristics, and the absence of windings or permanent magnets on the rotor and high peak torque-to-inertia ratios make them well suited for high-speed applications. SRMs find application in aerospace, high speed applications, and consumer appliances, such as washing machines and electric bicycles. Additionally, SRMs are considered as strong contenders for auxiliary power application in vehicular systems, non-conventional energy sources, and other industrial machineries and equipments.

However, despite the advantages, known SRMs have had limited commercial success because of a number of limitations, including high levels of torque ripple, acoustic noise, vibration, and relatively low torque density. These limitations can be partly attributed to their salient pole structure and control strategy. Therefore, there is a desire in the art to minimize the problem of torque ripple, increase torque production, and otherwise improve the operation of SRMs.

### SUMMARY OF THE INVENTION

The present invention provides new configurations of switched reluctance machines (SRM) having an improved relationship between the number of stator poles and rotor poles so as to provide a SRM with a minimal amount of torque ripple while providing increased power density and torque production. Particularly, the present invention provides SRM configurations having a rotor pole and stator pole numerical relationship of S number of stator poles, where S>4, and R number of rotor poles, which can be expressed as R=2S−2, such as a S/R pole count in 6/10, 8/14, or 10/18 configurations.

The SRM of this invention can be designed as a rotary, a linear, an axial or an external rotor type of machine, with three or more phases. The SRM of this invention does not mandate any unusual requirements on the power electronics and control techniques and is readily and easily adaptable to existing and contemporary control strategies, switching schemes, and circuit configurations developed for conventional SRMs, thus making it very practical for present commercial implementation and adoption. Further, known methods for improving the performance of conventional SRMs including pole shaping, current profiling, short flux excitation, sensorless algorithms, minimal flux reversing operations, can be extended to the SRMs of this invention to derive similar performance enhancements.

The SRM of this invention can offer several advantages over known SRMs including: high efficiency with lower copper loss; improved thermal performance; lower torque ripple; higher torque density; and lower costs for mass production. It is expected that these performance advantages will boost the acceptance level of the SRMs and successfully fulfill the promises of SRMs being potential candidates for many applications.

### BRIEF DESCRIPTION OF THE DRAWINGS

The objects and features of this invention will be better understood from the following detailed description taken in conjunction with the drawings wherein:

FIG. 1 illustrates a known SRM with six stator poles and four rotor poles;

FIG. 2 is a schematic of a typical control circuit configuration for an SRM;

FIG. 3 illustrates flux lines in the known SRM of FIG. 1 at an aligned position;

FIG. 4 is a perspective view of an SRM according to one embodiment of the invention with an axial configuration having six stator poles and ten rotor poles;

FIG. 5 is a perspective view of a stator for the embodiment of FIG. 4;

FIG. 6 is a perspective view of a stator with an alternative coil position for an embodiment of an axial SRM;

FIG. 7 is a perspective view of a rotor for the embodiment of FIG. 4; and

FIG. 8 is a SRM according to one embodiment of the invention with an external rotor configuration and having six stator poles and ten rotor poles.

### DETAILED DESCRIPTION OF THE PREFERRED EMBODIMENTS

Although the invention will be principally described with reference to embodiments of a SRM having six stator poles and ten rotor poles, machines of other sizes and having other than three phases or six stator poles may be designed in accordance with the invention.

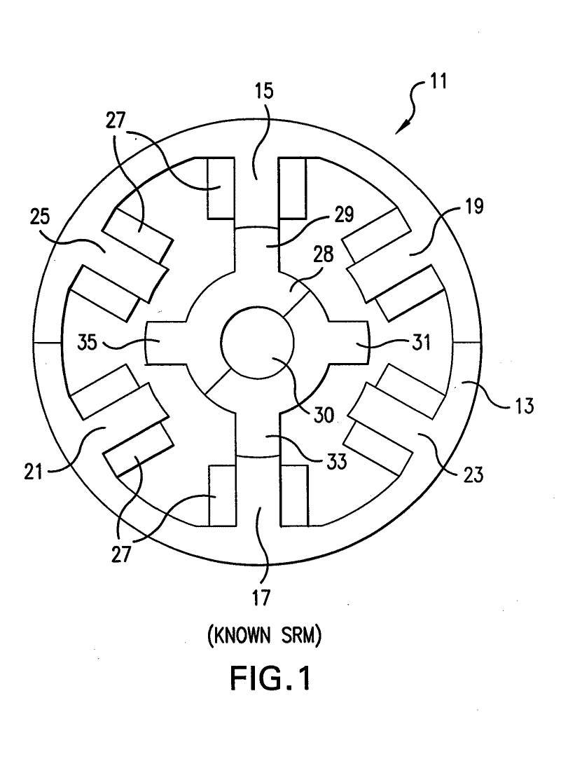

FIG. 1 illustrates a known construction of a three-phase salient pole SRM 11. The known SRM 11 includes a stator 13 with six stator poles 15, 17, 19, 21, 23, each having a coil, collectively 27, wound around each stator pole. The coils on diametrically opposite stator pole pairs i.e. 15/17, 19/21, and 23/25 are connected in series or in parallel to form a phase of the machine. In general, the number of poles in a stator is double the number of phases. Hence, the machine shown in FIG. 1 is a three-phase machine (Phases A, B and C) with six stator poles 15/17, 19/21, and 23/25, respectively. The rotor 28, affixed to a central rotatable shaft 30, has four rotor poles 29, 31, 33, 35.

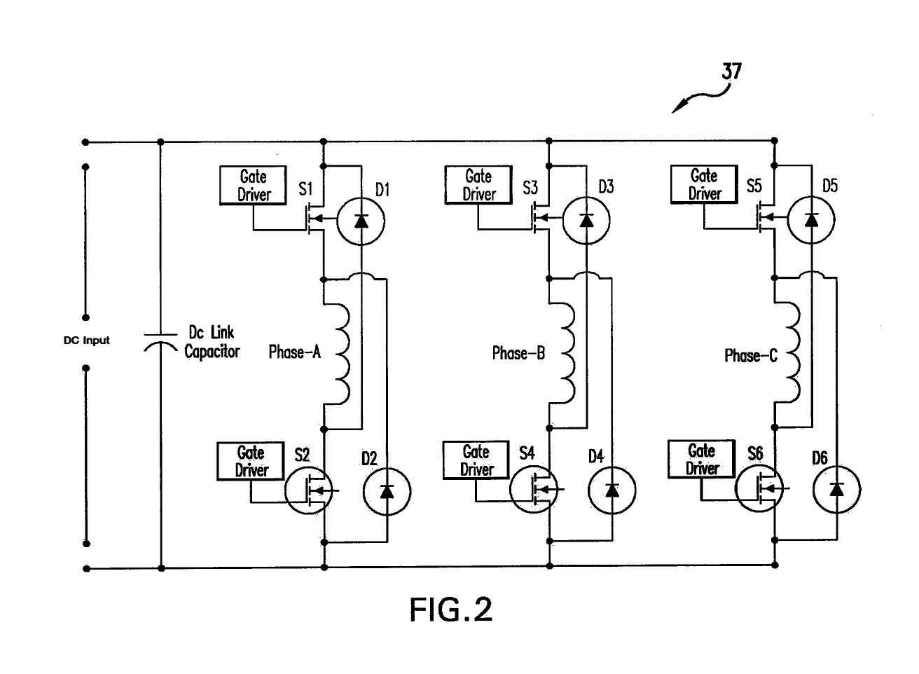

To operate the SRM 11 as a motor, each phase is normally connected to an electrical energy source through semiconductor devices. FIG. 2 illustrates one such circuit configuration 37. Current flow can be diverted to the different Phases A, B, C, by rotor position-based control of the switches S1 through S6. Clock-wise sequencing of phase excitation would produce counter-clock-wise rotation of the shaft and vice versa. Usually a phase is kept energized until any two of the rotor poles align themselves with those stator poles having energized coils. This position is referred to as a minimum reluctance position because reluctance to the flux path is at its least between opposite stator poles when the coils on those stator poles experience current flow. The next phase would then be energized once the rotor poles are aligned with corresponding stator poles, e.g., 15/29 and 17/33 as shown for the position in FIG. 1. In the shown position, it is appropriate to energize phase-B, stator poles 19/21, to turn the rotor in a counter-clock-wise direction, or energize phase-C, stator poles 23/25, to turn the rotor in a clock-wise direction. Subsequent serial phase excitation would than result in continuous rotation of the rotor.

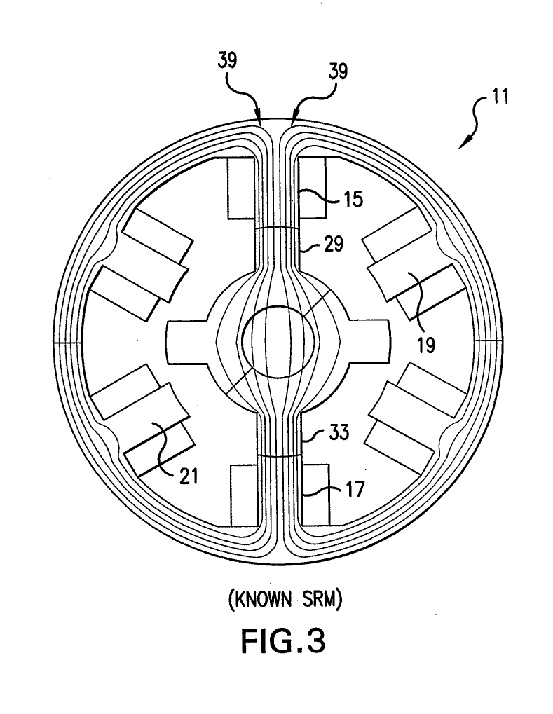

FIG. 3 shows a distribution of flux lines, collectively 39, when phase-A is energized and rotor poles 29, 33 are aligned to corresponding stator poles 15, 17, respectively. At this minimum reluctance position, the SRM 11 will produce the least torque and hence it is no longer efficient to continue exciting phase-A. Exciting phase-B will cause the rotor to align itself with stator poles having coils connected to Phase B poles 19, 21 to offer a minimum reluctance path to the flux lines established by current in the Phase B coils and hence rotor 28 will turn counter-clockwise to the next aligned position with the Phase B poles 19, 21.

U.S. Pat. No. 7,230,360, issued on 12 Jun. 2007, herein incorporated by reference, described an SRM having a rotor pole and stator pole numerical relationship of S number of stator poles, where S>4, and R number of rotor poles, which can be expressed as R=2S−2. This SRM showed significant improvements in torque ripple, torque density, efficiency and noise reduction over conventional SRMs.

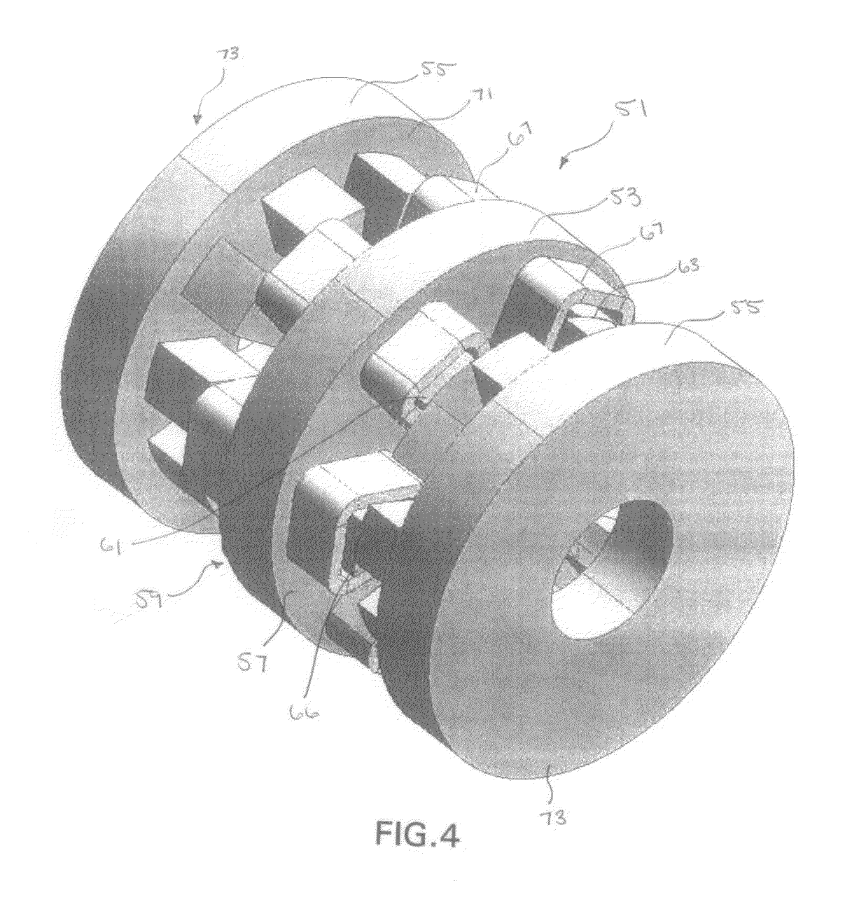

FIG. 4 shows a perspective view of an SRM 51 according to one embodiment of this invention. The SRM 51 has an axial configuration including a stator 53 positioned between a pair of rotors 55 which rotate about an axis. In this embodiment, the stator 53 and the rotors 55 are manufactured from stacked layers of laminated silicon steel sheets which provide low core losses, however, any magnetic material could be used. The SRM of this axial configuration is modular or stackable and can include any number of stators 53 and rotors 55 necessary to achieve a desired torque output or any other design consideration. In another embodiment, the SRM can include a single stator and a single rotor.

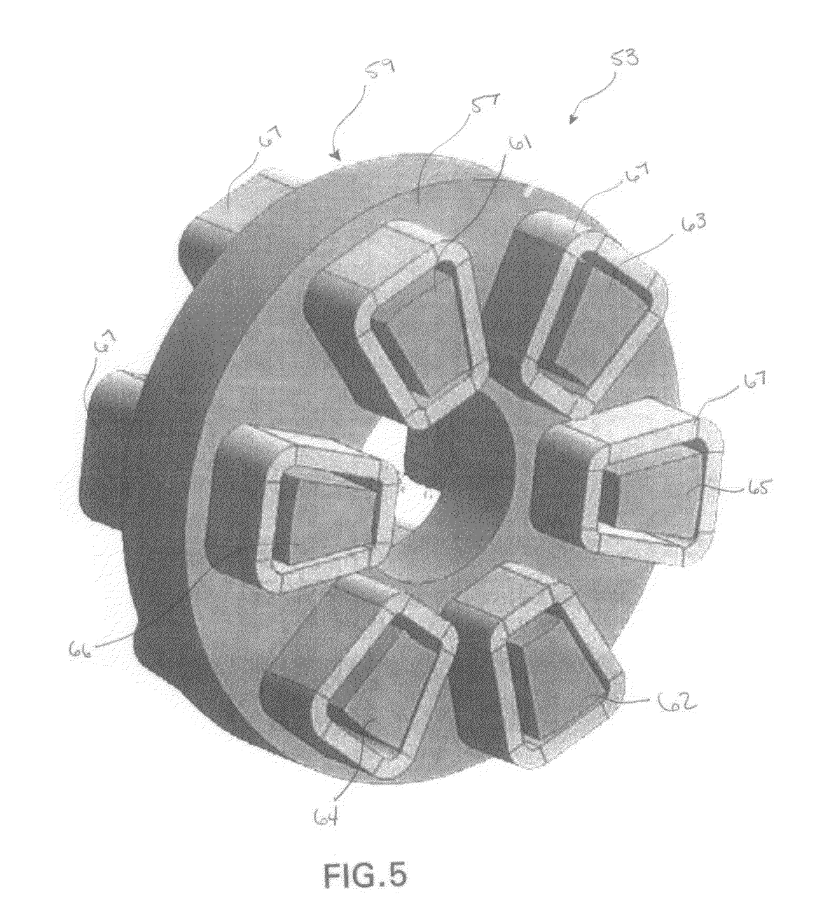

FIG. 5 shows a perspective view of the stator 53 of FIG. 4. The stator 53 has a disk-like shape with a first stator surface 57 and a second stator surface 59. The first stator surface 57 and the opposing second stator surface 59 are generally parallel to each other and each include a plurality of stator poles 61, 62, 63, 64, 65, 66 evenly distributed about a circumference of the stator 53. The stator poles 61, 62, 63, 64, 65, 66 project outward, e.g., generally perpendicular, from the corresponding one of the first stator surface 57 or the second stator surface 59. In this embodiment, each stator surface 57, 59 includes six stator poles in three-phase pairs 61/62, 63/64, 65/66. Each stator pole 61, 62, 63, 64, 65, 66 has a coil, collectively 67, wound around it. Each of the coils 67 is made of a magnetic wire, preferably copper, wrapped around a respective stator pole. Stator poles 61/62 with their associated coils represent phase A. Stator poles 63/64 and their coils represent phase B. Stator poles 65/66 and their coils represent phase C. In operation, the six stator poles on the opposing sides of the stator 53 operate in synch with each other.

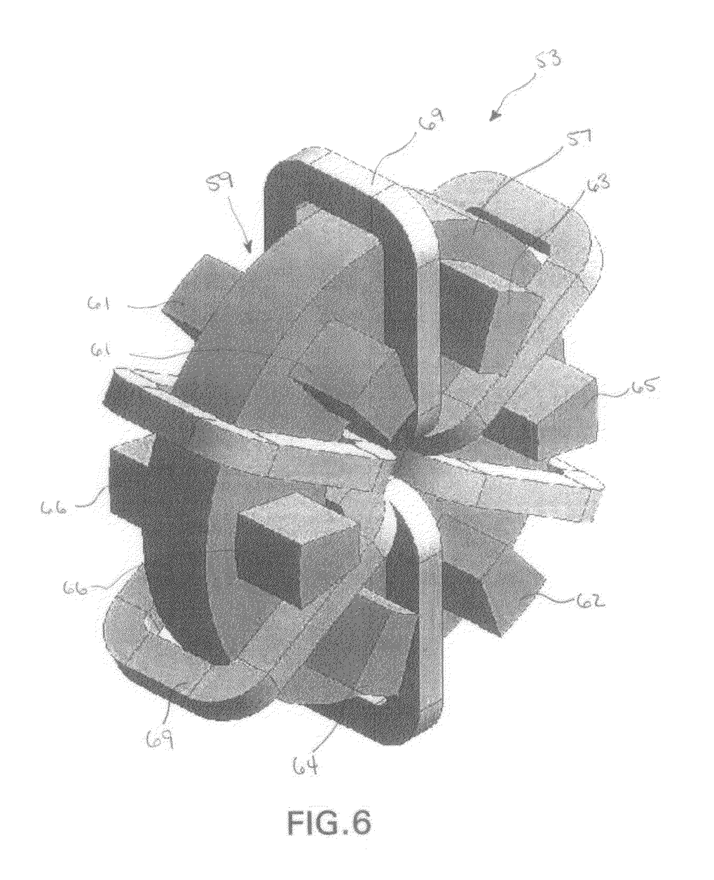

FIG. 6 shows the stator 53 of FIG. 4 with an alternative coil arrangement. In this embodiment, each of a plurality of coils 69 are wound around a portion of the stator 53 and adjacent to a corresponding one of the stator poles 61, 62, 63, 64, 65, 66. In this alternative arrangement, a single winding of coils can be used to energize a pair of stator poles, one on the first stator surface 57 and one on the second stator surface 59.

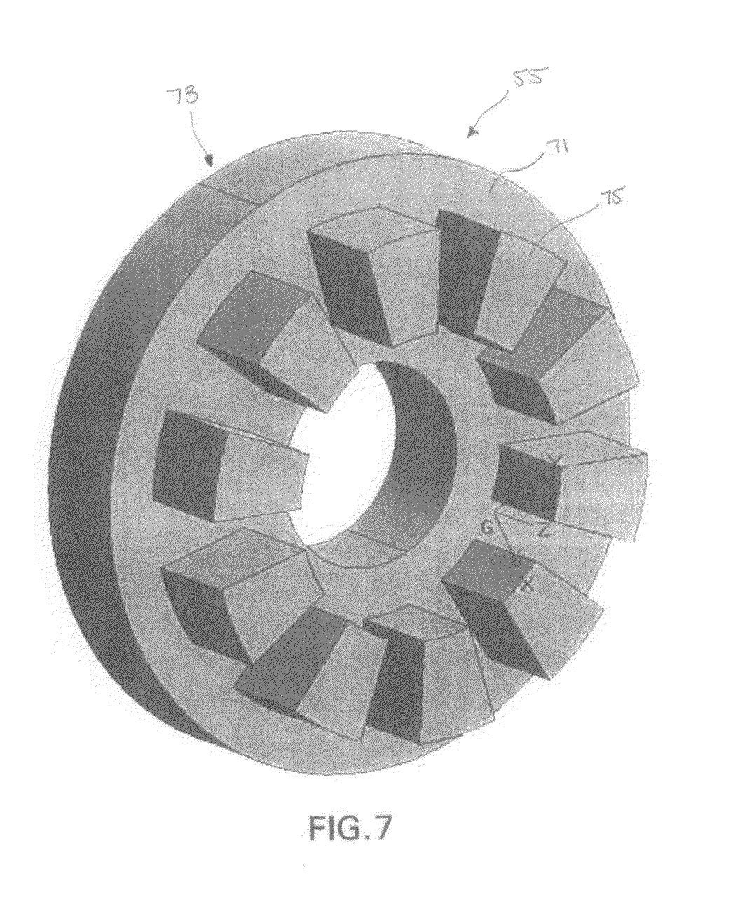

FIG. 7 shows the rotor 55 of FIG. 4. In this embodiment, the rotor 55 has a disk-like shape with a first rotor surface 71 and a second rotor surface 73. The first rotor surface 71 and the second rotor surface 73 are positioned on opposite sides of the disk-like shape and are generally parallel to each other. In FIG. 7, the rotor 55 includes a plurality of rotor poles 75 evenly distributed about a circumference of the rotor 55 and which project generally perpendicular from the first rotor surface 71. In an alternative embodiment, the rotor 55 can include a second set of rotor poles which project generally perpendicular from the second rotor surface 73.

The electrical control circuit configuration 37 as shown in FIG. 2 can be readily adapted for the present invention. From the aligned position of phase A, it will be appropriate to excite the coils of phase-B poles 63/64 or phase-C poles 65/66 for counter-clock-wise or clock-wise rotation. This will cause the rotor poles to align themselves to the corresponding stator poles to offer a least reluctance path.

In the embodiment of FIG. 4, the SRM 51 has six stator poles 61, 62, 63, 64, 65, 66 and ten rotor poles 75. However, the number of stator poles and the number of rotor poles can be any number that is defined by the formula: number of rotor poles (R)=(2 times the number of stator poles (S)) minus 2, or R=2S−2, where S>4, such as a S/R pole count in a 6/10, 8/14, or 10/18 configuration.

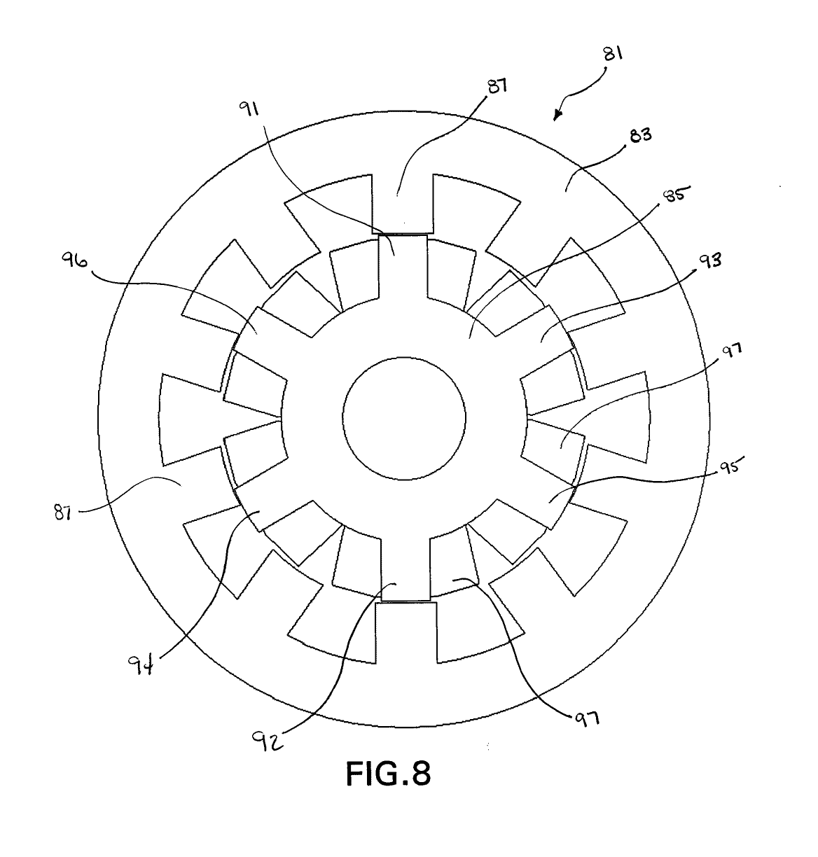

FIG. 8 illustrates another embodiment of the present invention in the form of an SRM 81 with an inverted configuration. In this embodiment, the SRM 81 has an external rotor 83 which is concentric with an internal stator 85. In this embodiment, the external rotor 83 and the internal stator 85 are manufactured from stacked layers of laminated silicon steel sheets which provide low core losses, however, any magnetic material could be used. The SRM 81 is a three-phase machine with six stator poles in three phase-pairs 91/92, 93/94, 95/96. Each stator pole 91, 92, 93, 94, 95, 96 has a coil, collectively 97, wound around it. Each of the coils 97 is made of a magnetic wire, preferably copper, wrapped around a respective stator pole. Stator poles 91/92 with their associated coils 97 represent phase A. Stator poles 93/94 and their associated coils 97 represent phase B. Stator poles 95/96 and their associated coils 97 represent phase C. Ten salient rotor poles, collectively 87, are located on the external rotor 83.

The electrical control circuit configuration 37 as shown in FIG. 2 can also be readily adapted for the present invention. From the aligned position as shown in FIG. 8, it will be appropriate to excite the coils of phase-B poles 93/94 or phase-C poles 95/96 for counter-clock-wise or clock-wise rotation, respectively. This will cause the rotor poles to align themselves to the corresponding stator poles to offer a least reluctance path.

In the embodiment of FIG. 8, the SRM 81 comprises six stator poles 91, 92, 93, 94, 95, 96 and ten rotor poles 87. However, the number of stator poles and the number of rotor poles can be any number that is defined by the formula: number of rotor poles (R)=(2 times the number of stator poles (S)) minus 2, or R=2S−2, where S>4, such as a S/R pole count in a 6/10, 8/14, or 10/18 configuration.

The SRM configurations of this invention are not limited to any particular switching schemes, control strategies, or circuit configuration thus making aspects of this invention very practical for present commercial implementation. For example, the methods of operation discussed above for current SRMs, such as standard switching schemes and circuit topologies, will be equally suitable for the SRM configurations of this invention.

The SRMs of the present invention give machine designers an additional degree of freedom to realize better efficiency, reduced noise and torque ripple, desirable torque-speed profiles, higher power density, and superior torque characteristics. These performance advantages can help boost the acceptance level of the SRMs and successfully fulfill the promises of SRMs being potential candidates for electro-mechanical energy conversion equipment.

It will be appreciated that details of the foregoing embodiments, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

What is claimed is:

1. A switched reluctance machine comprising:
a rotor arranged to rotate about a central axis, the rotor comprising a set of rotor poles;
a stator positioned adjacent and axial to the rotor, the stator comprising a set of stator poles; and
wherein the rotor poles and the stator poles are in a numerical relationship defined by the formula:
number of rotor poles (R)=(2 times the number of stator poles (S)) minus 2, or R=2S−2, where S>4.

2. The switched reluctance machine of claim 1 wherein the stator further comprises a first stator surface and the rotor further comprises a rotor surface, the rotor surface positioned generally parallel to and facing the first stator surface.

3. The switched reluctance machine of claim 2 wherein the stator poles project generally perpendicular from the first stator surface and the rotor poles project generally perpendicular from the rotor surface.

4. The switched reluctance machine of claim 3 wherein the stator further comprises a second stator surface on an opposite side from, and generally parallel to, the first stator surface, and the switched reluctance machine further comprising:
a second rotor arranged to rotate about the central axle, the second rotor including a second rotor surface positioned generally parallel to and facing the second stator surface, the second rotor further comprising a set of rotor poles projecting generally perpendicular from the second stator surface.

5. The switched reluctance machine of claim 3 further comprising a plurality of stators and a plurality of rotors arranged about the central axis to increase an output torque of the switched reluctance machine.

6. The switched reluctance machine of claim 1 wherein the switched reluctance machine is a three phase type.

7. The switched reluctance machine of claim 1 wherein S=6 and R=10.

8. The switched reluctance machine of claim 1 wherein S=8 and R=14.

9. The switched reluctance machine of claim 1 wherein S=10 and R=18.

10. The switched reluctance machine of claim 1 further including a plurality of coils, each of the plurality of coils winding around a respective stator pole.

11. The switched reluctance machine of claim 10 further including an electrical control circuit operably attached to each of the plurality of coils.

12. The switched reluctance machine of claim 1 further including a plurality of coils, each of the coils winding around a portion of the stator and adjacent to a respective stator pole.

13. The switched reluctance machine of claim 12 further including an electrical control circuit operably attached to each of the plurality of coils.

14. The switched reluctance machine of claim 1 wherein the number of stator poles is double a number of phases.

15. A switched reluctance machine comprising:
a stator including a plurality of stator poles;
a rotor including a plurality of rotor poles, the rotor at least partially surrounding and arranged to rotate around the stator; and
wherein the rotor poles and the stator poles are in a numerical relationship defined by the formula:
number of rotor poles (R)=(2 times the number of stator poles (S)) minus 2, or R=2S−2, where S>4.

16. The switched reluctance machine of claim 15 wherein the switched reluctance machine is a three phase type.

17. The switched reluctance machine of claim 15 wherein S=6 and R=10.

18. The switched reluctance machine of claim 15 wherein S=8 and R=14.

19. The switched reluctance machine of claim 15 wherein S=10 and R=18.

20. The switched reluctance machine of claim 15 further including a plurality of windings, each of the windings surrounding a respective stator pole.

21. The switched reluctance machine of claim 20 further including an electrical control circuit operably attached to the plurality windings.

22. The switched reluctance machine of claim 15 wherein the number of stator poles is double a number of phases.

23. The switched reluctance machine of claim 15 wherein one pair of stator poles is energized per phase of the switched reluctance machine.
